(19) United States
(12) Patent Application Publication
(10) Pub. No.: US 2007/0245257 A1
(43) Pub. Date: Oct. 18, 2007

(54) Graphical Interface for Direct Manipulation of Software Objects

(76) Inventors: Kwan-Ho Chan, Lubbock, TX (US); Jeffrey Jee Hui Tiong, Singapore (SG); Qi Xian He, Singapore (SG)

Correspondence Address: MEDICINELODGE INC., 180 SOUTH 600 WEST, LOGAN, UT, 84321, US

(21) Appl. No.: 11/466,608

(22) Filed: Aug. 23, 2006

Related U.S. Application Data
(60) Provisional application No. 60/711,264, filed on Aug. 24, 2005.

(51) Int. Cl. G06F 3/048

(52) U.S. Cl. 715/769

(57) ABSTRACT

An intuitive user interface is provided for carrying out operations on software objects. The software objects may be databases, and the operations may be Boolean operations. The software objects may be represented by icons, and may be stored hierarchically within a system of folders. Each of Boolean operators may also have an icon, which may operate as a folder. A first software object may be selected and activated by associating it with a desired Boolean operator, for example, by clicking and dragging the first software object onto the icon for the desired Boolean operation. A second software object may then be selected and associated with the activated first software object, for example, by clicking and dragging the second software object onto the icon for the activated first software object. The desired Boolean operation may then be performed to provide an output software object represented by an icon.

### CROSS-REFERENCE TO RELATED APPLICATIONS

This application claims the benefit of:

U.S. Provisional Application No. 60/711,264, filed Aug. 24, 2005, which carries Applicants' docket no. Chan-052408, and is entitled GRAPHICAL INTERFACE FOR DIRECT MANIPULATION OF SOFTWARE OBJECTS.

The foregoing is incorporated herein by reference.

### BACKGROUND OF THE INVENTION

1. The Field of the Invention

This application relates to graphical user interfaces for manipulating software objects. More particularly, the present invention relates to providing drag-and-drop functionality for manipulation of software objects in association with pre-defined operators.

2. The Relevant Technology

Data in the form of a database or a collection of text or numbers can be transformed by predefined algorithms or mathematical formulae into output data. Two or more sets of data can also be combined and transformed using predefined algorithms or mathematical formulae into one or more sets of output data.

One specific example of such data manipulation is the use of queries for acquiring data from databases. SQL (Structured Query Language) is a standardized query language for requesting information from databases. This technology was developed by IBM in the mid-1970s as a way to move information into and out of relational database management systems. In using SQL, the user creates a statement declaring what data is desired. The software takes the statement and manipulates the data in accordance with the request. This is usually done by typing the statement on the keyboard and entering the statement into the computer. This is generally known as the “command line” approach.

In general, inputting queries with the command line approach is cumbersome and tedious. The user needs to be provided with an input area on the display screen, and the user is required to type out the query. This is particularly tedious if the databases' names are long and hard to remember. Furthermore, the user must be familiar with the rules of the query language and the available commands. Therefore, command line inputs are prone to typographical errors and errors in the structure of the query itself.

Boolean operators are commonly used in the construction of queries in SQL and other forms of query language. When several Boolean operators are used in a single query, care has to be taken to avoid ambiguity in the query and to ensure that the correct sequence of operations is carried out. Correct pairs of parentheses must be appropriately placed to group the intended logical sets of operations. Accordingly, the use of command line input when multiple Boolean operators are included in a single query is error prone and at times hard to interpret.

Recognizing the limitation of using command line input for manipulation of data, and in particular databases, a number of systems have been developed in an attempt to address these deficiencies. However, these systems generally require multiple steps to perform the intended manipulations on a group of data. Furthermore, these prior art methods oftentimes are not intuitive for the understanding of the underlying Boolean expression. Hence, Boolean relationships can be difficult to recognize among the input data.

Accordingly, it is desirable to have a graphical method of constructing database queries and other operations in which the user is presented with a clear visual relationship between the input data to the underlying operators, such as Boolean expressions. It is also desirable to have an intuitive method using simple graphical maneuvers to manipulate software objects. Furthermore, it would be highly desirable to provide methods in which complex operations such as complex Boolean queries can be constructed in a stepwise fashion.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 illustrates a screen on which several software objects are represented by icons.

FIG. 2 illustrates the screen of FIG. 1 after some of the icons in FIG. 1 have been moved to a different location.

FIG. 3 illustrates a screen on which several software objects are represented by icons, and Boolean operations that can be performed on the software objects are also represented by icons.

FIG. 4 illustrates the screen of FIG. 3 after the “Apple” software object has been activated by copying its icon into a hierarchical position beneath the “OR” Boolean operation.

FIG. 5 illustrates the screen of FIG. 4 after the “Orange” software object has been associated with the activated “Apple” software object by associating the “Orange” icon with the activated “Apple” icon to create an activated “(Apple OR Orange)” software object.

FIG. 6 illustrates the screen of FIG. 5 after the “Strawberry” software object has been associated with the activated “(Apple OR Orange)” software object to form an “((Apple OR Orange) OR Strawberry)” object.

FIG. 7 illustrates the screen of FIG. 6 after the activated “((Apple OR Orange) OR Strawberry)” object has been moved into a hierarchical position beneath a “Fruit Juice” Folder.

FIG. 8 illustrates the screen of FIG. 5 after the “AND” Boolean operation has been performed on the “Orange” and “Strawberry” software objects to create an activated “(Orange AND Strawberry)” software object.

FIG. 9 illustrates the screen of FIG. 8 after the activated “(Orange AND Strawberry)” software object has been associated with the activated “(Apple OR Orange)” software object to form an activated “((Apple OR Orange) OR (Orange AND Strawberry))” software object.

FIG. 10 illustrates the screen of FIG. 3, in which the “Orange” and “Strawberry” software objects have been activated by copying their icons into hierarchical positions beneath the “OR” Boolean operation.

FIG. 11 illustrates the screen of FIG. 10, after the “Orange” software object has been associated with the activated “Apple” software object by associating the “Orange” icon with the activated “Apple” icon to create an “(Apple OR Orange)” software object, and the “Strawberry” software object has been associated with the activated “Orange” icon to create an activated “(Orange OR Strawberry)” software object.

FIG. 12 illustrates the screen of FIG. 11, in which the “(Orange OR Strawberry)” software object has been activated by copying its icon into a hierarchical position beneath the “AND” Boolean operation.

FIG. 13 illustrates the screen of FIG. 12, in which the “Strawberry” software object has been associated with the activated “(Apple OR Orange)” software object to create an activated “((Apple OR Orange) OR Strawberry)” software object, and the “Apple” software object has been associated with the activated “(Orange OR Strawberry)” software object to create an activated “((Orange OR Strawberry) AND Apple)” software object.

### DETAILED DESCRIPTION OF THE PREFERRED EMBODIMENTS

The present invention relates to methods of manipulating software objects. The drawings and accompanying description are merely exemplary. Accordingly, the scope of the present invention is not intended to be limited by the examples discussed herein, but only by the appended claims.

The present invention provides an intuitive method of directly and graphically manipulating software objects. In one preferred embodiment of the invention, the method uses a computer with a display screen and a mouse with one or more buttons. The cursor on the display screen is controlled by movement of the mouse. It will be clear to those skilled in the art that other forms of pointers may alternatively be used to control the cursor. Software objects such as executable computer programs, short cuts, data files and folders are represented by icons with or without an associated label on the display screen. Folders are special software objects functioning as containers for other software objects, including other folders. In general, folders and subfolders represent virtual containers where icons representing software objects such as executable computer programs, short cuts, and data files reside. Folders provide a convenient way to organize these software objects into a hierarchal directory tree structure.

One common method of manipulating software objects using the mouse is to “drag and drop” one or more selected icons from one location to another location on the display screen. For the purpose of this specification the terms “software objects” and “objects” are used interchangeably. The drag and drop maneuver is equivalent to picking up a physical object and moving it to a different physical location. It involves the steps of attaching the cursor to an icon, moving the cursor and the attached icon to a different location, and releasing the cursor from the attached icon to leave the icon at the new location. The software object represented by the icon may or may not be moved or altered by this process.

One method of attaching the cursor to an icon is by positioning the cursor in the vicinity of the icon and depressing one of the mouse buttons. As long as the mouse button is depressed, the cursor remains attached to the icon. The icon is “dragged” to a different location by moving the cursor while keeping the mouse button depressed. Once the desired location is reached, the mouse button is released and the icon remains in the new location. For the purpose of clarity, this type of drag and drop maneuver may be called a “drag and move” maneuver to distinguish it from other variations of the drag and drop maneuver.

One variation of the drag and drop maneuver is the creation of a copy of the icon and/or the represented software object in the new location while the original icon remains in the starting location. This variation of the drag and drop maneuver will be referred to as “drag and copy.” There are at least two ways to select whether the “drag and move” or the “drag and copy” maneuver is to be executed.

One selection method is to make the selection context sensitive. In this method, predefined source objects, icons, or target locations are pre-selected to be associated with the drag and move operation or with the drag and copy operation. In this manner, either maneuver can be initiated with the same mouse manipulation. For example if an icon representing a computer file is dragged and dropped into a folder in the same hard drive, the computer file will be moved to the target folder. The predefined context rule in the preceding example is “if a source file is dragged and dropped into a target folder and both are in the same hard drive, then the drag and move is implemented.”

By extension, a different rule is used if the same icon is dragged and dropped into a target folder residing in another hard drive. In this case, a copy of the source file is deposited into the target folder. The predefined context rule in the preceding example is “if a source file is dragged and dropped into a target folder and both are not in the same hard drive, then the drag and copy is implemented.” Another way of selecting whether drag and move or drag and copy is to be executed is by depressing the left button for drag and move, and depressing the right button for drag and copy.

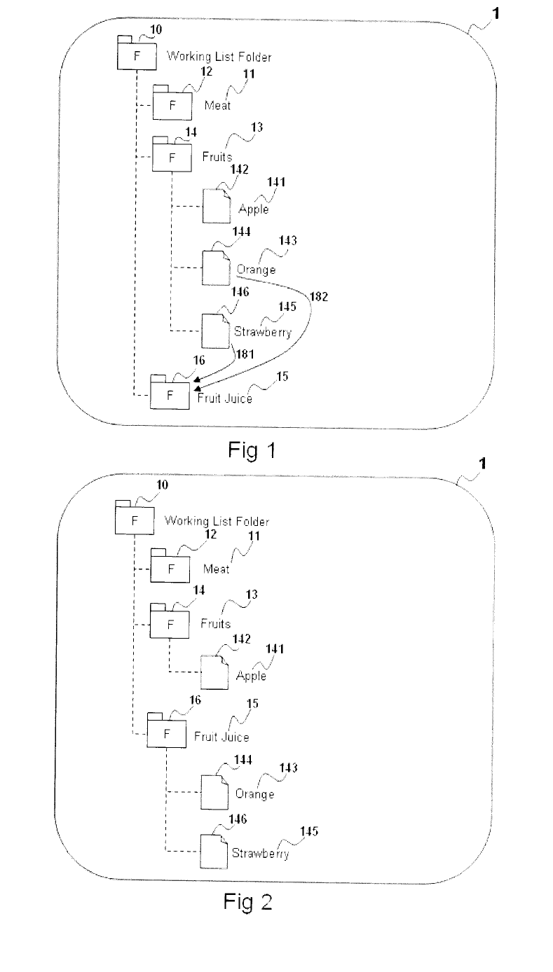

Referring to FIG. 1, a window 1 within the display screen contains a folder 10 with subfolders 12, 14, 16. A folder 12 is labeled “Meat” 11 indicating that this folder 12 contains icons representing software objects related to Meat. A folder 14 is labeled “Fruits” 13 and contains three icons 142, 144, 146 and the associated labels “Apple” 141, “Orange” 143, and “Strawberry” 145. By way of example, the icons 142, 144, 146 may represent software objects comprising data files, or databases, containing lists of suppliers of apples, oranges, and strawberries, respectively. The solid lines 181 and 182 indicate that two icons 144 and 146 are selected and dragged and dropped into a target folder 16 labeled “Fruit Juice” 15.

Selecting a software object may be carried out by selecting the icon that represents it. Accordingly, “selecting an icon” and “selecting a software object” will be used interchangeably hereafter. The icons 142, 144, 146 may thus be referred to as software objects, or objects. Similarly, “dragging and dropping a software object” may also be used interchangeably with “dragging and dropping the icon” representing the software object. Those of skill in the art will recognize that the represented software object may not be moved by the drag and drop operation, but is nonetheless selected and/or activated via its icon according to the actions performed by the user.

Referring to FIG. 2, the objects 144 and 146 and their associated labels 143, 145 now reside in the folder 16 after drag and drop operation has been carried out. The objects 144 and 146 contain the same data as they did prior to performance of the drag and drop operation.

According to known software interfaces, executable computer programs, short cuts, and data files may be drag and dropped into folders. These software objects remain unchanged in their final destinations. Known interfaces also permit a data file to be dragged and dropped into an executable computer program. Such a maneuver causes the executable computer program to process the data file in a predetermined manner. For example if a text file is dragged and dropped into an icon representing a printing program, the computer will cause the printer to print the text file. However, known interfaces generally do not carry out any operation in response to dragging and dropping one data file onto another data file.

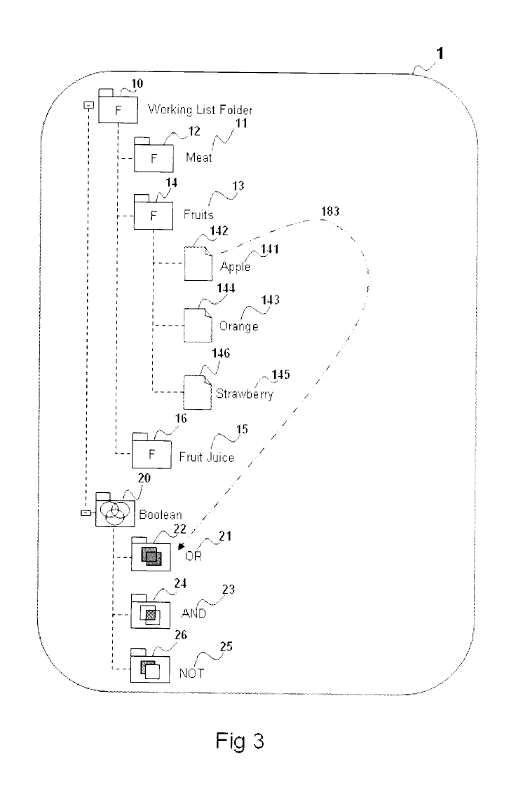

In one embodiment of this invention, the method of manipulating software objects includes a novel class of operator folders. In FIG. 3, the root operator folder 20 contains three operator folders 22, 24, 26 each associated with a predefined operation. By way of example, the operator folders 22, 24, 26 and their associated labels 21, 23, 25 represent the Boolean operations OR, AND, and NOT, respectively. The broken line 183 in FIG. 3 represents dragging and dropping the selected “Apple” object 142 into operator folder 22 labeled OR 21.

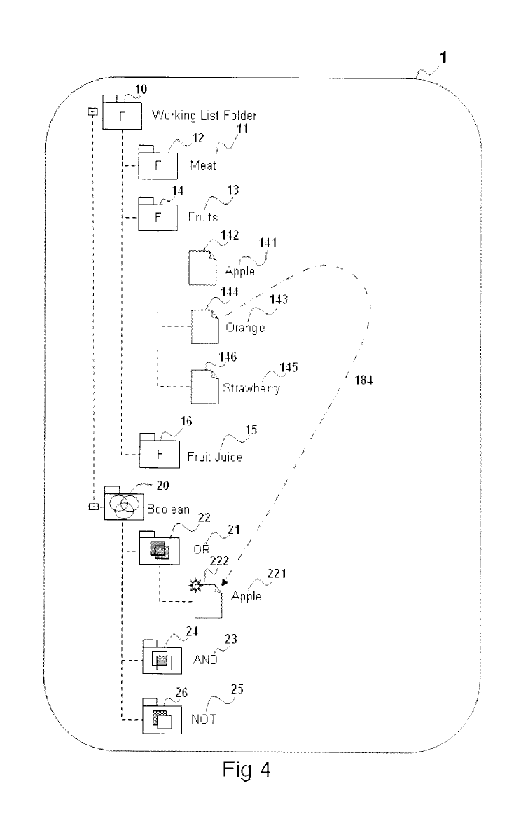

Referring to FIG. 4, after the drag and drop maneuver 182, a new object 222 with label “Apple” 221 is created. In one embodiment of the invention, the object 222 is conveniently represented by a different class of icons. By way of example a star is added to the top left hand corner of the original icon of object 142 to create a new class of icons. The purpose of this is to indicate that object 222 is an activated object and is now capable of receiving another compatible software object. The activated object 222 either is the same as the original object 142, or is a copy that contains the same data as the original object 142. In addition, the activated object 222 is now capable of interacting with another compatible object in accordance with the operation associated with the operation folder 22. The broken line 184 in FIG. 4 indicates that the object 144 with label “Orange” 143 is dragged and dropped into the activated object 222.

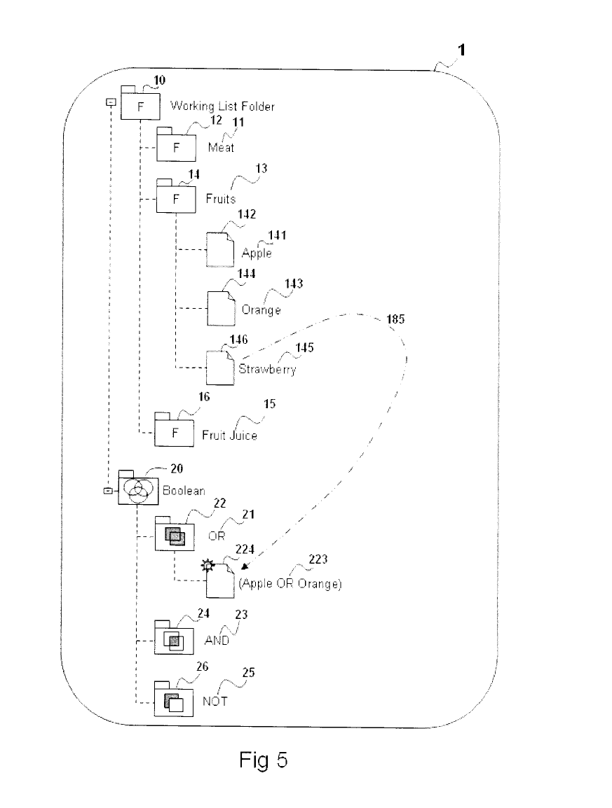

Referring to FIG. 5, the object 222 is shown after combination with the object 144 in accordance to the OR Boolean operation. The result is a new object 224 containing a new set of data as indicated by the new label “(Apple OR Orange)” 223. The new object 224 remains as an activated object and is capable of interacting with another compatible object in accordance with the operation associated with the operation folder 22. By way of example, the broken line 185 in FIG. 5 indicates that the object 146 with label “Strawberry” 145 is dragged and dropped into the activated object 224.

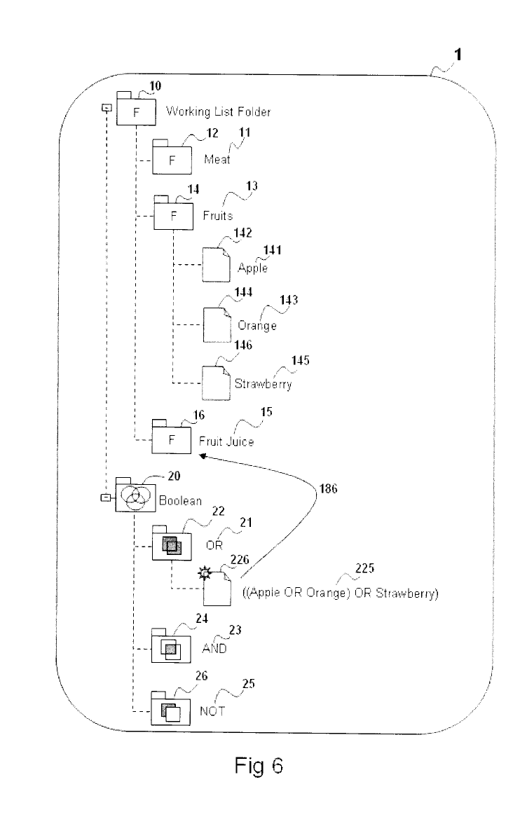

Referring to FIG. 6, the resulting object 226 and its associated label “((Apple OR Orange) OR Strawberry)” are shown. The new object 226 contains a new set of data resulting from the combination of the object 146 with the object 224 in accordance with the operator associated with the operator folder 22 which, in this particular example, is the “OR” Boolean operation. This new object 226 remains as an activated object and is capable of further interaction with another compatible object in accordance with the operation associated with the operation folder 22. In FIG. 6, the solid line 186 indicates that the activated object 226 is dragged and dropped into a regular folder 16.

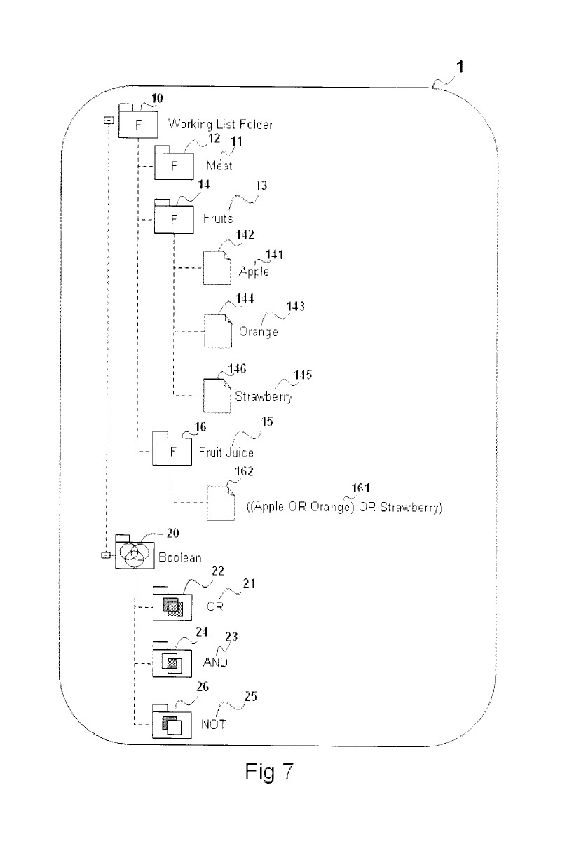

Referring to FIG. 7, the resulting object 162 now contains a list of suppliers who are capable of supplying apples or oranges or strawberries. After an activated object is dragged and dropped into a regular folder such as the folder 16, the object 162 is no longer an active object as indicated by an icon which is common to the parent objects 142, 144, 146 from which object 162 is derived. The object 162 may have the same format and properties as the parent objects 142, 144, 146. Accordingly, computer programs that are capable of processing the parent objects 142, 144, 146 may also be able to process the object 162.

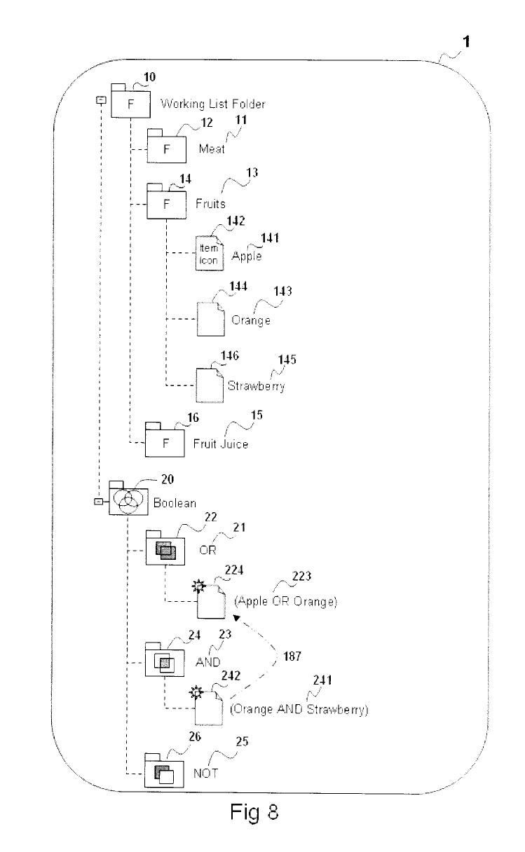

Referring to FIG. 8, in yet another embodiment of the invention, an activated object can associate with other activated objects via drag and drop functionality. As indicated by the broken line 187, an activated object 242 with the label “(Orange AND Strawberry)” 241 is dragged and dropped into an activated object 224 with the label “(Apple OR Orange)” 223.

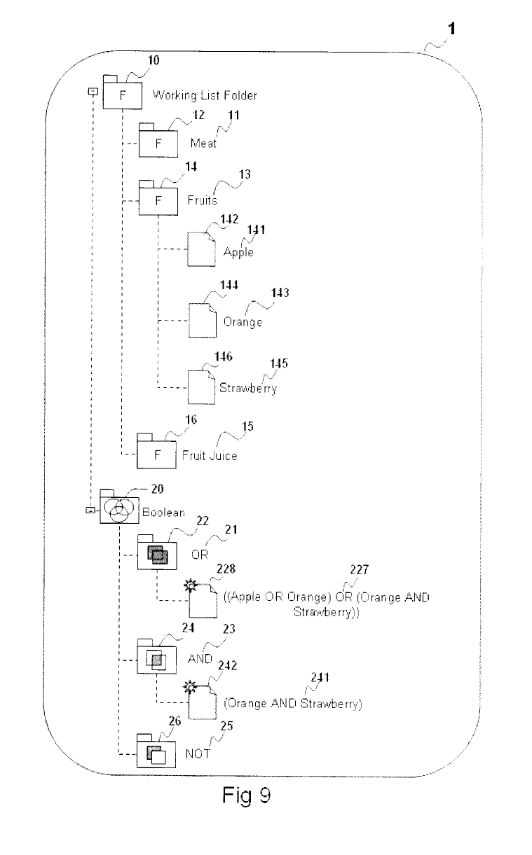

Referring to FIG. 9, the resulting object 228 has the label 227 “((Apple OR Orange) OR (Orange AND Strawberry)).” It will be apparent to one of skill in the art that this invention provides an intuitive graphical method of constructing a very complex sequence of operations in a step wise manner. Advantageously, the label 227 provides a record of the sequence of operations for easy reference.

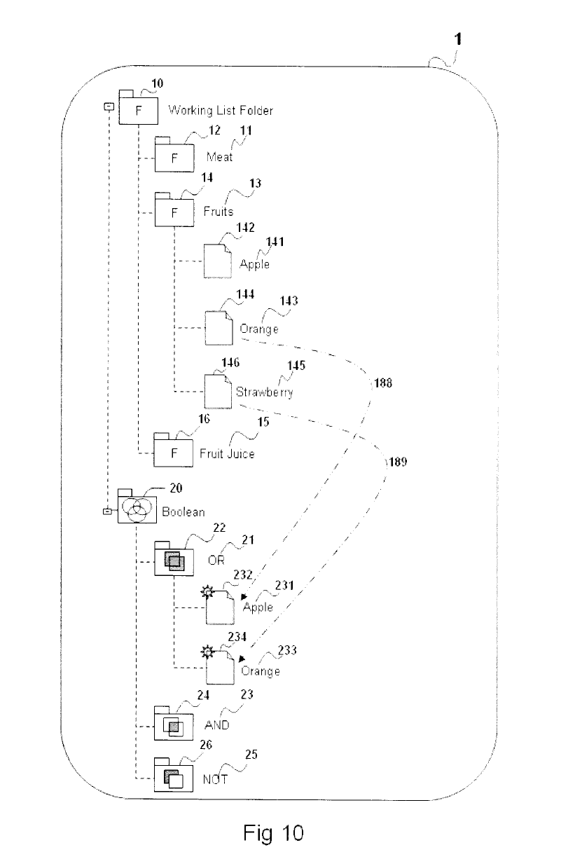

Referring to FIG. 10, the present invention allows the user to create multiple active objects 232, 234 within a single operator folder in manners previously described. The object 144 with the label “Orange” 143 is dragged and dropped into the activated object 232 with label “Apple” 231.

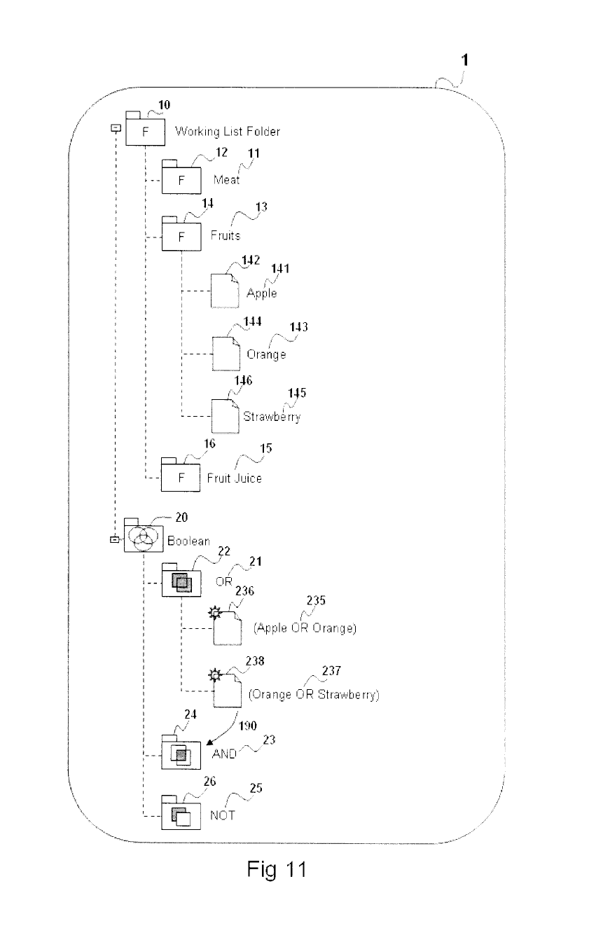

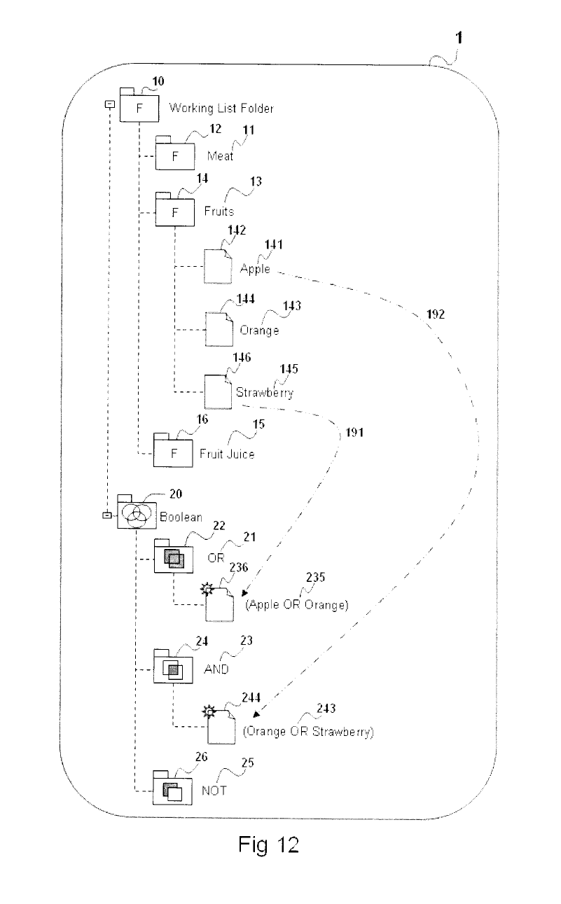

Referring to FIG. 11, this drag and drop operation results in the creation of a new activated object 236 with the label “(Apple OR Orange)” 235. Similarly, dragging and dropping the object 146 with the label “Strawberry” 145 into the activated object 234 with the label “Orange” 233 results in the creation of a new activated object 238 with the label “(Orange OR Strawberry)” 237. This invention also allows the user to drag and drop an activated object from one operator folder to another operator folder. By way of example, the solid line 190 in FIG. 11 is to indicate that the object 238 is dragged and dropped into operator folder 24.

Referring to FIG. 12, this results in the creation of a new activated object 244 with the label “(Orange OR Strawberry)” 243. The activated object 244 contains the same data as its predecessor activated object 238. The object 244 differs from its predecessor object 238 in that the object 244 can now interact with another compatible object in accordance to the operator associated with operator folder 24 which, in this is case, is the Boolean operator “AND.” The broken line 191 in FIG. 12 indicates a drag and drop of the object 146 with the label “Strawberry” 145 into the activated object 236 with the label “(Apple or Orange)” 235.

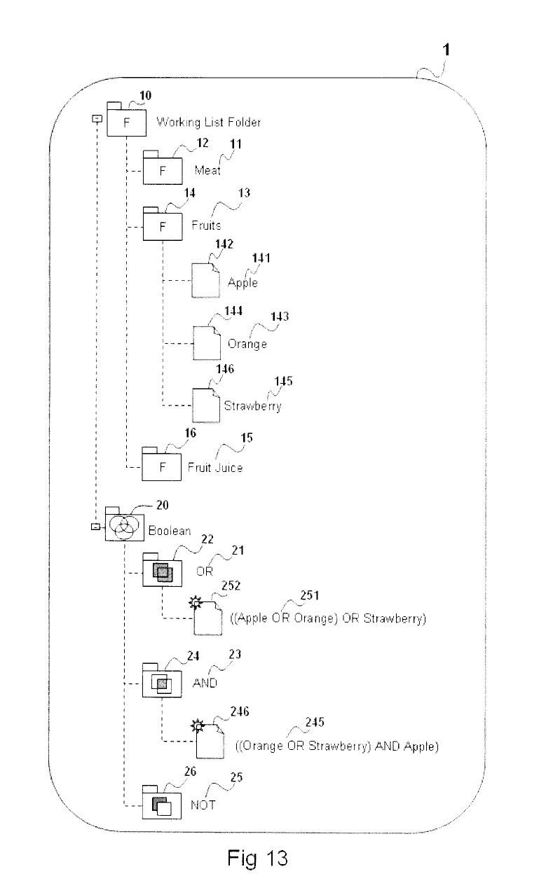

Referring to FIG. 13, the activated object 252 with label “((Apple OR Orange) OR Strawberry)” 251 is the combination of the activated object 236 with the object 146 using the operator associated with the operator folder 22. In this case, the associated operator is the Boolean operator “OR.” Similarly, the broken line 192 in FIG. 12 indicates a drag and drop of object 142 with label Apple 141 into the object 244 with the label “(Orange OR Strawberry)” 243. A resulting object 246 with the label “((Orange OR Strawberry) AND Apple)” 245 is the combination of the activated object 244 with the object 142 using the operator associated with the operator folder 24. In this case, the associated operator is the Boolean operator “AND.”

In one embodiment of this invention, the following events are represented by the solid lines in FIGS. 1, 6 and 11: a) an object in a regular folder is dragged and dropped into another regular folder as shown in FIG. 1 (181, 182); b) an activated object is dragged and dropped into a regular folder as shown in FIG. 6 (186); and c) an activated object is dragged and dropped into another operator folder as shown in FIG. 11 (190). These actions may be implemented as drop and move operations.

Similarly, the following events are represented by the broken lines in FIGS. 3, 4, 5, 8, 10 and 12: a) an object in a regular folder is dragged and dropped into operator folder as shown in FIG. 3 (183); b) an object in a regular folder is dragged and dropped into an activated object as shown in FIG. 4 (184), FIG. 5 (185), FIG. 10 (188, 189) and FIG. 12 (191, 192); and c) an activated object is dragged and dropped into another activated object as shown in FIG. 8 (187). These actions may be implemented as drag and copy operations.

The present invention may be embodied in other specific forms without departing from its spirit or essential characteristics. It is appreciated that various features of the systems and methods described above can be mixed and matched to form a variety of other alternatives. As such the described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for manipulating software objects to perform a desired operation, the method comprising:
selecting a first software object;
associating the first software object with a desired operation to create an activated first software object;
selecting a second software object;
associating the second software object with the activated first software object; and
performing the desired operation on the second software object and the activated first software object.

2. The method of claim 1, wherein the first software object is represented by a first graphical representation on a screen, wherein selecting the first software object comprises using an input device to select the first graphical representation.

3. The method of claim 2, wherein the input device comprises a mouse, wherein selecting the first graphical representation comprises clicking on the first graphical representation with the mouse.

4. The method of claim 3, wherein associating the first software object with the desired operation comprises using the mouse to move the first graphical representation to a location on the screen corresponding to the desired operation.

5. The method of claim 1, wherein performing the desired operation comprises performing a Boolean operation.

6. The method of claim 5, wherein the first software object comprises a first database and the second software object comprises a second database.

7. The method of claim 6, further comprising creating an output database containing data from the first and second databases according to the Boolean operation.

8. The method of claim 1, further comprising:
creating an output software object according to the desired operation;
selecting a third software object;
associating the third software object with a second desired operation to create an activated third software object; and
performing the second desired operation on the output software object and the activated third software object.

9. A method for manipulating software objects to perform a desired operation, the method comprising:
selecting a first graphical representation on a screen, the first graphical representation representing a first database;
selecting a second graphical representation on the screen, the second graphical representation representing a second database; and
performing a Boolean operation on the first and second databases.

10. The method of claim 9, wherein selecting the first graphical representation comprises clicking on the first graphical representation with a mouse, wherein selecting the second graphical representation comprises clicking on the second graphical representation with the mouse.

11. The method of claim 10, further comprising using the mouse to move the first graphical representation to a location on the screen corresponding to the Boolean operation.

12. The method of claim 9, further comprising creating an output database containing data from the first and second databases according to the Boolean operation.

13. The method of claim 9, further comprising:
creating an output database according to the Boolean operation;
selecting a third graphical representation on the screen, the third graphical representation corresponding to a third database; and
performing a second Boolean operation on the output database and the third database.

14. A computer-readable medium containing computer code for carrying out a method, the method comprising:
selecting a first software object;
associating the first software object with a desired operation to create an activated first software object;
selecting a second software object;
associating the second software object with the activated first software object; and
performing the desired operation on the second software object and the activated first software object.

15. The computer-readable medium of claim 14, wherein the first software object is represented by a first graphical representation on a screen, wherein selecting the first software object comprises using an input device to select the first graphical representation.

16. The computer-readable medium of claim 15, wherein the input device comprises a mouse, wherein selecting the first graphical representation comprises clicking on the first graphical representation with the mouse.

17. The computer-readable medium of claim 16, wherein associating the first software object with the desired operation comprises using the mouse to move the first graphical representation to a location on the screen corresponding to the desired operation.

18. The computer-readable medium of claim 14, wherein performing the desired operation comprises performing a Boolean operation.

19. The computer-readable medium of claim 18, wherein the first software object comprises a first database and the second software comprises a second database.

20. The computer-readable medium of claim 19, wherein the method further comprises creating an output database containing data from the first and second databases according to the Boolean operation.

21. The computer-readable medium of claim 14, wherein the method further comprises:
creating an output software object according to the desired operation;
selecting a third software object;
associating the third software object with a second desired operation to create an activated third software object; and
performing the second desired operation on the output software object and the activated third software object.

22. A computer-readable medium containing computer code for carrying out a method, the method comprising:
selecting a first graphical representation on a screen, the first graphical representation representing a first database;
selecting a second graphical representation on the screen, the second graphical representation representing a second database; and
performing a Boolean operation on the first and second databases.

23. The computer-readable medium of claim 22, wherein selecting the first graphical representation comprises clicking on the first graphical representation with a mouse, wherein selecting the second graphical representation comprises clicking on the second graphical representation with the mouse.

24. The computer-readable medium of claim 23, wherein the method further comprises using the mouse to move the first graphical representation to a location on the screen corresponding to the Boolean operation.

25. The computer-readable medium of claim 22, wherein the method further comprises creating an output database containing data from the first and second databases according to the Boolean operation.

26. The computer-readable medium of claim 22, wherein the method further comprises:
creating an output database according to the Boolean operation;
selecting a third graphical representation on the screen, the third graphical representation corresponding to a third database; and
performing a second Boolean operation on the output database and the third database.
